(19) United States
(12) Patent Application Publication
(10) Pub. No.: US 2018/0266145 A1
(43) Pub. Date: Sep. 20, 2018

(54) Door Handle with Electronic Lock Assembly

(71) Applicant: Kuo-Chi Chou, Taipei City (TW)

(72) Inventor: Kuo-Chi Chou, Taipei City (TW)

(21) Appl. No.: 15/919,296

(22) Filed: Mar. 13, 2018

(30) Foreign Application Priority Data
Mar. 17, 2017 (TW) 106203756

(51) Int. Cl. E05B 47/00; E05B 49/00; E05B 63/00; E05B 63/24

(52) U.S. Cl. CPC E05B 47/0001; E05B 49/002; E05B 2047/0054; E05B 63/248; E05B 2047/0017; E05B 63/0008

(57) ABSTRACT

A door handle with electronic lock assemble comprises a door handle and a connecting rod. The door handle is deposited on a side of a door. The connecting rod is rotatable mounted on the door handle by crossing through the door. The door comprises a lock operatively connected with the door handle and the connecting rod. The door handle comprises an electronic module mounted therein. The electronic module comprises a controller, an actuator module and an electronic key interface. The controller and the actuator are signal connected. The electronic key interface is electronic connected with the controller.

### BACKGROUND OF THE INVENTION

### 1. Field of the Invention

Present invention is related to an electronic lock, especially to the electronic lock integrated with a door handle.

### 2. Description of the Prior Art

A conventional electronic door lock comprises an external panel assembly and an internal panel assembly being operatively connected with a door lock. The external panel assembly and an internal panel assembly are deposited on respective sides of a door with a connecting rod passing through. The external panel assembly and the internal panel assembly comprise an electronic module respectively to control an opening and locking mechanism of the door. Door handles are mounted on the rod on the respective sides of the door. Users have to input a preset password via the external panel assembly to unlock the conventional electronic door lock.

In order to have enough room to install the electronic module inside, the external panel assembly and the internal panel assembly are usually large in size which affects the appearance of the door.

### SUMMARY OF THE INVENTION

In order to solve shortcomings of the conventional electronic lock, a door handle with electronic lock assembly is required.

The door handle with electronic lock assembly comprises a door handle and a connecting rod. The door handle is deposited on a side of a door. The connecting rod is rotatable mounted on the door handle by crossing through the door. The door comprises a locking structure operatively connected with the door handle and the connecting rod. The door handle comprises an electronic module mounted therein. The electronic module comprises a controller, an actuator module and an electronic key interface. The controller and the actuator are signal connected. The electronic key interface is electronic connected with the controller.

By installing electronic module inside the door handle, the present invention may reduce the size of the conventional electronic lock. Extra panel assemblies will no longer required. With using the present invention, it reduces troublesome to install the electronic lock.

Other objectives, advantages and novel features of the invention will become more apparent from the following detailed description when taken in conjunction with the accompanying drawings.

### BRIEF DESCRIPTION OF THE DRAWINGS

FIGS. 1, 2, 3a and 3b are illustrations of a first embodiment of a door handle with electronic lock assembly in accordance with the present invention;

FIGS. 4-5 are illustrations of a second embodiment of a door handle with electronic lock assembly in accordance with the present invention;

FIG. 6 is an illustration of a third embodiment of a door handle with electronic lock assembly in accordance with the present invention; and

FIG. 7 is a cross-section view of an embodiment of an input panel of a door handle with electronic lock assembly in accordance with the present invention.

### DETAILED DESCRIPTION OF THE INVENTION

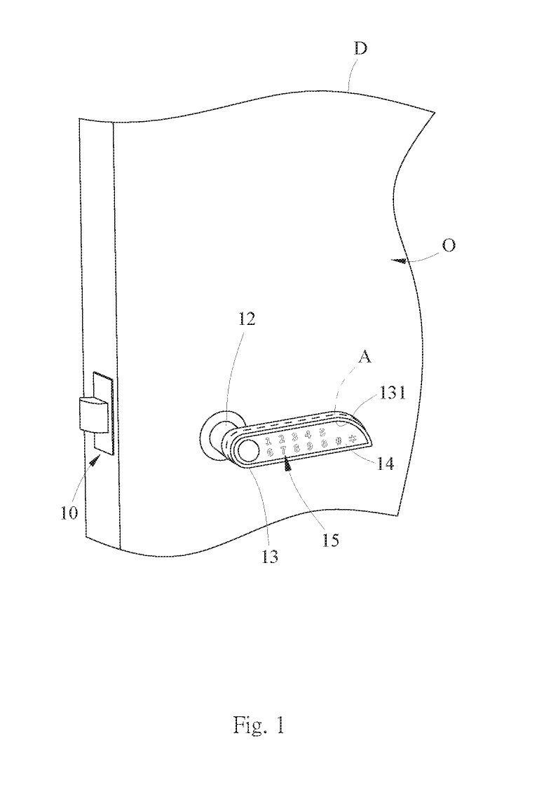

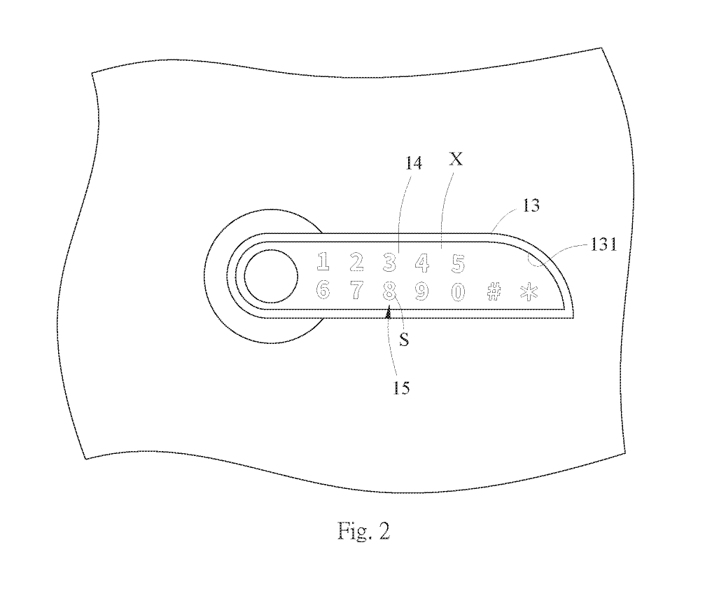

With reference to FIGS. 1, 2, 3a and 3b, a first embodiment of door handle with electronic lock assembly of the present invention comprises at least an external door handle 13 and a connecting rod 12. The external door handle 13 is deposited on an outer side O of a door D during use. The connecting rod 12 is mounted on the external door handle 13 by crossing through the door D. The connecting rod 12 is rotatable placed in the door D. The door D include a locking structure 10 which is operatively connected with the external door handle 13 and the connecting rod 12. A shape of the external door handle 13 in this embodiment is preferred to be cylinder-like or bar-like shapes.

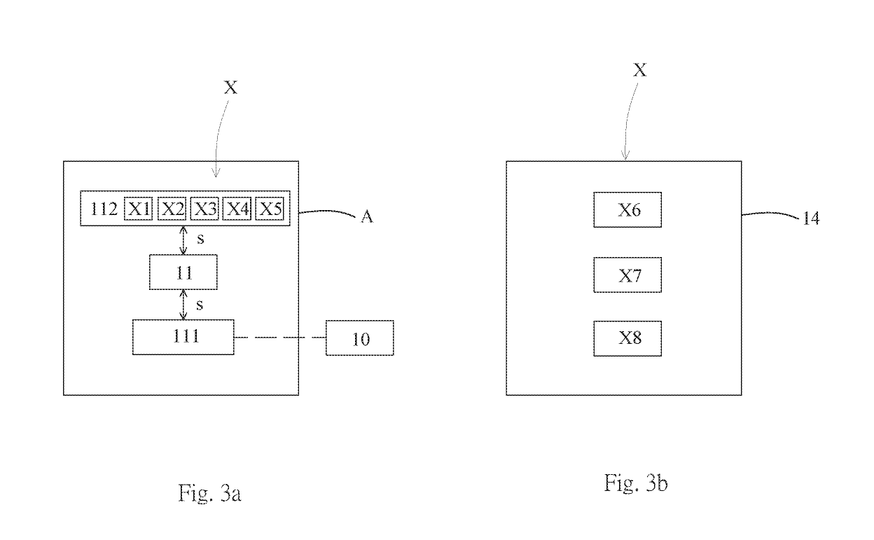

The external door handle 13 comprises a recess 131 formed in its surface. An electronic module A is mounted in the recess 131. The electronic module A comprises a controller 11, an actuator module 111 and an electronic key interface X. The electronic key interface X in this embodiment is a wireless communication module 112. The controller 11, the actuator module 111 and the wireless communication module 112 are signal connected (as shown in FIG. 3a as reference number s). The wireless communication module 112 may be but not limited to a blue-tooth communication module X1, an infrared ray communication module X2, a near-field communication module X3, a Wi-Fi communication module X4 or a Zigbee communication module X5. The wireless communication module 112 in this embodiment is preferred to be the near-field communication module X3. When the wireless communication module 112 received an input signal of a preset wireless key, the controller 11 will unlock the locking structure 10 by controlling the actuator module 111.

A second embodiment of the electronic key interface X is an input panel 14 being mounted in the recess 131. The input panel 14 may be but not limited to a resistance-type touch-screen X6, a capacitance-type touch-screen X7 or a keypad X8. The input panel 14 is electronic connected with the controller 11. The input panel 14 is preferred to comprise at least one button 15 thereon. The said button 15 may be an icon on the touch-screen X6, X7 or a true button on the keypad X8. Each button comprises a symbol S marked thereon. A number of the button 15 in this embodiment is twelve. The symbols S marked on these twelve buttons 15 are “0”, “1”, “2”, “3”, “4”, “5”, “6”, “7”, “8”, “9”, “*” and “#” in this embodiment. When a preset password is input by activating these buttons, the controller 11 unlocks the locking structure 10 by driving the actuator module 111.

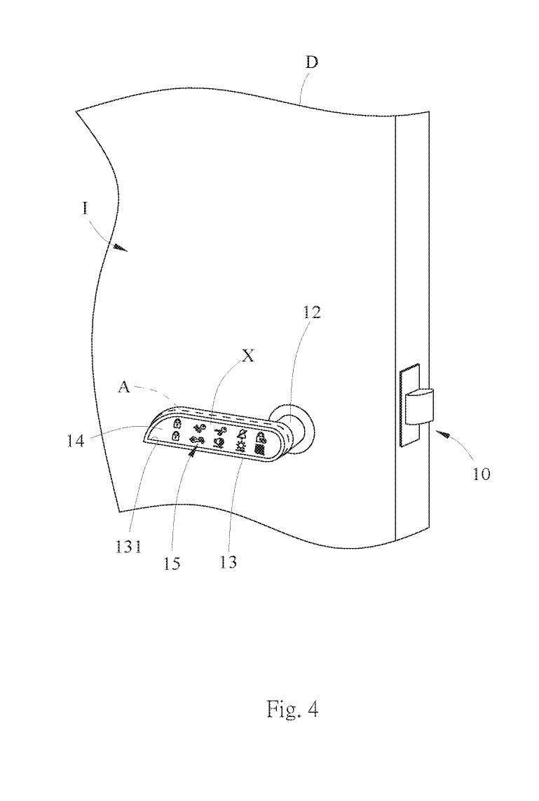

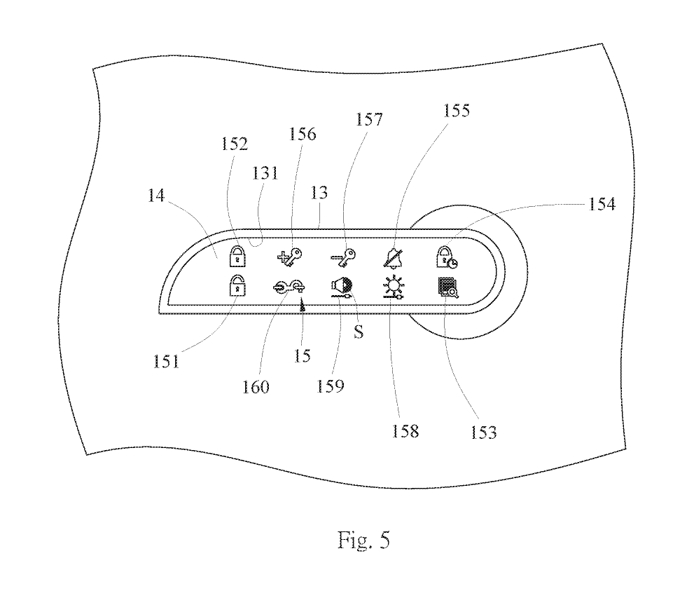

With reference to FIGS. 4-5, a second embodiment of door handle with electronic lock assembly of the present invention comprises at least an internal door handle 13 and a connecting rod 12. The internal door handle 13 is deposited on an inner side I of a door D. The connecting rod 12 is mounted on the internal door handle 13 the door D. The connecting rod 12 is rotatable placed in the door D. The door D include a locking structure 10 which is operatively connected with the internal door handle 13 and the connecting rod 12. A shape of the internal door handle 13 in this embodiment is preferred to be cylinder-like or bar-like shapes.

The internal door handle 13 comprises a recess 131 on its surface. An electronic module A (same as the first embodiment shown in FIGS. 3a and 3b) is mounted in the recess 131. The electronic module A comprises a controller 11, an actuator module 111 and an electronic key interface X. The electronic key interface X in this embodiment is an input panel 14 being mounted in the recess 131. The input panel 14 may be but not limited to a resistance-type touch-screen X6, a capacitance-type touch-screen X7 or a keypad X8. The input panel 14 is electronic connected with the controller 11. The input panel 14 is preferred to comprise at least one button 15 mounted thereon. The said button 15 may be an icon on the touch-screen X6, X7 or a true button on the keypad X8. Each button comprises a symbol S marked thereon. A number of the button 15 in this embodiment is ten. The symbols S marked on these ten buttons 15 are preferred to be a “unlock” symbol 151, a “lock” symbol 152, a “menu” symbol 153, a “timing lock” symbol 154, a “mute” symbol 155, a “add keys” symbol 156, a “reduce keys” symbol 157, a “brightness adjustment” symbol 158, a “volume adjustment” symbol 159 and a “locking from inside” symbol 160. These symbols S represent functions to be operated when users activate those buttons. When users activate those buttons 15 like pushing or pressing, a control signal will be input to the controller 11 to operative the functions marked thereon.

By installing the electronic module A, the wireless communication module 112 and the input panel 14 in the door handle 13, the present invention may reduce the size of the conventional electronic lock. Extra panel assemblies will no longer required.

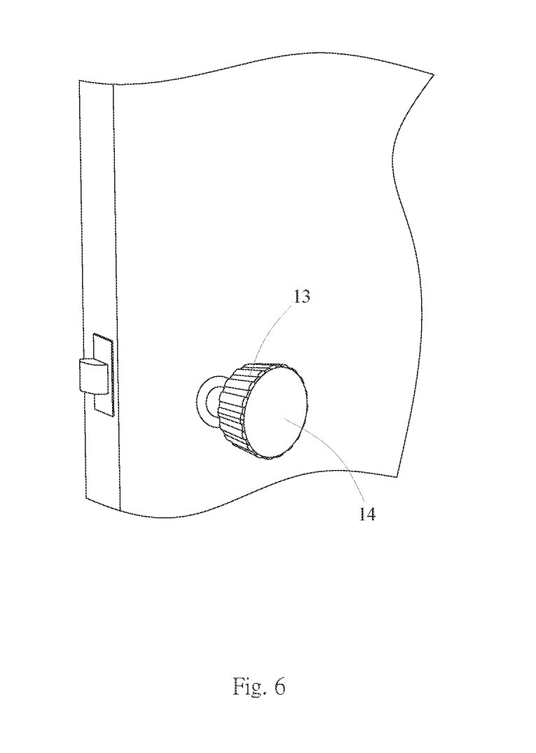

Except for the cylinder-like or bar-like shapes of the door handle 13 as described in the aforementioned embodiments, the shape of the external door hand 13 and the internal door handle 13 may be but not limited to square shape or round shape as shown in FIG. 6. The input panel 14 of this embodiment will also in round shapes corresponded to the shape of door handle of the present invention.

The locking structure 10 of the present invention is preferable to be operatively connected with the controller 11 via wire connection or wireless communication. The advantage of the wireless communication is that the door handle 13, the rod 12 and the locking structure 10 may be setup in different place which may enhance the difficulties to thief unlocking the door.

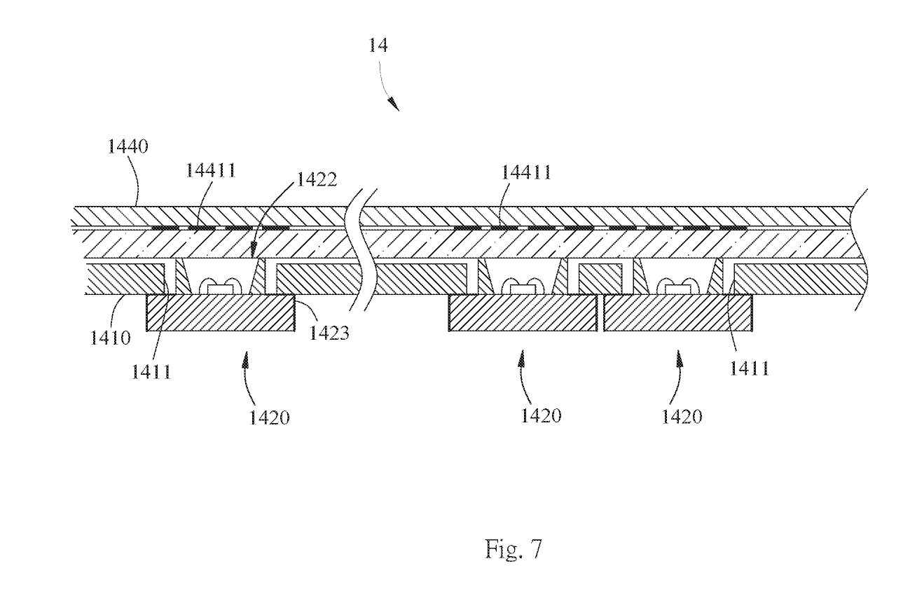

With reference to FIG. 7, to further reduce the size of the present invention, the input panel 14 may comprise a circuit board 1410, multiple light-emitting diodes (LED) 1420, a light diffusion plate 1430, multiple graphic layers 14411 and a touch panel 1440. The circuit board 1410 comprises multiple holes 1411 with a light emitting element 1422 of each LED 1420 mounted respectively therein. Every graphic layer 14411 is deposited on the light diffusion plate 1430 corresponded to the holes 1411. The light diffusion plate 1430 covers the circuit board 1410 which it is able to diffuse light being emitted from the LEDs. A base 1423 of each LED 1420 is electronic connected with the circuit board 1410. The circuit board 1410 controls the brightness of the LEDs 1420 and also control the LEDs being turned on or turned off for the adjustment of the electricity consumption of the present invention. When parts of LEDs 1420 being turned on through the circuit board 1410, parts of the graphic layers 14411 will be lighten up via parts of the holes 1411. Users may activate the present invention by touching the touch panel 1440 where the graphic layers 14411 were lighten up. Since part of the LEDs 1420 is installed in the circuit board 1410, the size or thickness of the present invention is able to be reduced furthermore.

What is claimed is:

1. A door handle with electronic lock assembly comprising a door handle and a connecting rod, wherein:
the door handle is deposited on a side of a door;
the connecting rod is rotatable mounted on the door handle by crossing through the door;
the door comprises a assembly operatively connected with the door handle and the connecting rod;
the door handle comprises an electronic module mounted therein;
the electronic module comprises a controller, an actuator module and an electronic key interface; wherein:
the controller and the actuator module are signal connected with each other; and
the electronic key interface is electronic connected with the controller.

2. The door handle with electronic lock assembly as claimed in claim 1, wherein the electronic key interface is a wireless communication module.

3. The door handle with electronic lock assembly as claimed in claim 1, wherein the electronic key interface is an input panel being mounted in a recess of the door handle; wherein:
the recess is deposited on a surface of the door handle;
at least one button is mounted on the input panel;
each button comprises a symbol marked thereon; and
the input panel is electronic connected with the controller.

4. The door handle with electronic lock assembly as claimed in claim 3, wherein the symbols are numbers from “0” to “9”.

5. The door handle with electronic lock assembly as claimed in claim 3, the symbols comprises at least a unlock button and a menu button.

6. The door handle with electronic lock assembly as claimed in claim 3, the symbols further comprises a lock symbol, a timing lock symbol, a mute symbol, a add keys symbol, a reduce keys symbol, a brightness adjustment symbol, a volume adjustment symbol and a locking from inside symbol.

7. The door handle with electronic lock assembly as claimed in claim 1, wherein the door handle with electronic lock further comprises a lock being wireless connected with the controller.

8. The door handle with electronic lock assembly as claimed in claim 2, wherein the door handle with electronic lock further comprises a lock being wireless connected with the controller.

9. The door handle with electronic lock assembly as claimed in claim 3, wherein the door handle with electronic lock further comprises a lock being wireless connected with the controller.

10. The door handle with electronic lock assembly as claimed in claim 4, wherein the door handle with electronic lock further comprises a lock being wireless connected with the controller.

11. The door handle with electronic lock assembly as claimed in claim 5, wherein the door handle with electronic lock further comprises a lock being wireless connected with the controller.

12. The door handle with electronic lock assembly as claimed in claim 3, wherein:
the input panel comprises a circuit board, multiple light-emitting diodes, a light diffusion plate, multiple graphic layers and a touch panel;
the circuit board comprises multiple holes with a light emitting element of each light-emitting diode mounted respectively therein;
every graphic layer is deposited on the light diffusion plate corresponded to the hole;
the light diffusion plate covers the circuit board and diffuse light being emitted from the light-emitting diodes; and
a base of each light-emitting diode is electronic connected with the circuit board.
